(19) United States
(12) Patent Application Publication
(10) Pub. No.: US 2026/0175240 A1
(43) Pub. Date: Jun. 25, 2026

(54) SPRAY NOZZLE ASSEMBLY OF A SPRAY VALVE AND ALIGNMENT ASSEMBLING METHOD THEREOF

(71) Applicant: HORNG TERNG AUTOMATION CO., LTD., Kaohsiung City (TW)

(72) Inventors: Wei-Chieh WANG, Kaohsiung City (TW); Shao-Xuan LU, Kaohsiung City (TW)

(21) Appl. No.: 19/274,749

(22) Filed: Jul. 21, 2025

(30) Foreign Application Priority Data
Dec. 25, 2024 (TW) 113150736

(51) Int. Cl. B05B 7/06

(52) U.S. Cl. CPC B05B 7/066

(57) ABSTRACT

A spray nozzle assembly includes a spray nozzle having a tapered alignment portion and an air nozzle having a tapered alignment recess. When the spray nozzle is placed in the air nozzle, an inner conical surface defined around the alignment recess abuts on an outer conical surface of the alignment portion. With the inner conical surface and the outer conical surface, the spray nozzle is able to slide with respect to the air nozzle to a predetermined position automatically. The spray nozzle and the air nozzle can be connected with each other without threaded structure, and gap and tolerance therebetween can be reduced. Accordingly, concentricity between the spray nozzle and the air nozzle is high, such that gel can be sprayed evenly.

### BACKGROUND OF THE INVENTION

### 1. Field of the Invention

The present invention relates a spray valve for atomizing gel, especially to a spray nozzle assembly of the spray valve and an alignment assembling method of the spray nozzle assembly.

### 2. Description of the Prior Art(s)

A spray valve is a device used to supply gel, especially for supplying liquid gel with low viscosity. The spray valve is connected to a gel dispensing equipment for atomizing gel to be sprayed on to-be-bonded components, such that the components are able to be bonded together. The spray valve is mainly applied to bonding and assembling processes of semiconductors.

With reference to FIG. 7, a conventional spray nozzle assembly of a spray valve comprises a spray nozzle 51, an adapting seat 52, an air nozzle 53, and a mounting seat 54. The spray nozzle 51 has a spray head 511, an extension portion 512 and a flow channel 513. The extension portion 512 extends down from a lower surface of the spray head 511. The flow channel 513 is formed through and between an upper surface of the spray head 511 and a lower end of the extension portion 512. The adapting seat 52 is mounted on the spray head 511 of the spray nozzle 51 and an upper part of the extension portion 512 to support the spray nozzle 51. The air nozzle 53 is connected with the adapting seat 52 through a threaded structure and is mounted around a lower part of the extension portion 512 of the spray nozzle 51. The mounting seat 54 is mounted around and supports the adapting seat 52, and is assembled with a valve body 61 of the spray valve through a threaded structure.

However, with further reference to FIG. 8, for the convenience of connecting, there are gaps in the threaded structure between the air nozzle 53 and the adapting seat 52 and in the threaded structure between the mounting seat 54 and the valve body 61. Thus, whenever each of the threaded structures is used for connecting, the spray nozzle 51 is inevitably deflected, causing the spray nozzle 51 and the air nozzle 53 being unable to be concentric. As concentricity between the spray nozzle 51 and the air nozzle 53 is poor and the spray nozzle 51 is deflected, the gel is unable to be sprayed on a component 62 evenly. Consequently, one part of the component 62 would have more gel, while another part of the component 62 would have less gel.

### SUMMARY OF THE INVENTION

In view of the aforementioned shortcomings and deficiencies, the present invention provides a spray nozzle assembly of a spray valve and an alignment assembling method of the spray nozzle assembly, which allow concentricity between a spray nozzle and an air nozzle being high, such that gel can be sprayed evenly.

In order to achieve the above-mentioned objective, the technical means of the present invention is to provide a spray nozzle assembly that has a spray nozzle and an air nozzle. The spray nozzle has: a spray nozzle head; an alignment portion protruding down from a bottom surface of the spray nozzle head, tapered downwardly, and having an outer conical surface; a spray mouth protruding down from a lower end of the alignment portion; and a flow channel formed through the spray nozzle head, the alignment portion and the spray mouth.

The air nozzle is mounted on the spray nozzle and has an air nozzle body and an air nozzle head. The air nozzle body has an alignment recess and a spray mouth recess formed within the air nozzle body. The alignment recess is formed concavely in a top of the air nozzle body and is tapered from the top of the air nozzle body towards a bottom of the air nozzle body such that the alignment recess is formed as a conical space and an inner conical surface is defined around the alignment recess. The alignment portion of the spray nozzle is disposed in the alignment recess of the air nozzle, and a taper angle of the inner conical surface matches with a taper angle of the outer conical surface of the alignment portion of the spray nozzle. The spray mouth recess is penetrated through and formed between the alignment recess and the bottom of the air nozzle body. The spray mouth of the spray nozzle is disposed in the spray mouth recess. The air nozzle head is disposed on the top of the air nozzle body and disposed around the spray nozzle head.

The taper angle of the outer conical surface of the alignment portion of the spray nozzle is equal to or greater than the taper angle of the inner conical surface of the air nozzle body of the air nozzle. A difference between the taper angle of the outer conical surface and the taper angle of the inner conical surface is less than or equal to 1 degree.

In order to achieve the above-mentioned objective, another technical means of the present invention is to provide an alignment assembling method of the spray nozzle assembly. The alignment assembling method includes steps of:
providing a spray nozzle, wherein the spray nozzle has: a spray nozzle head; an alignment portion protruding down from a bottom surface of the spray nozzle head, tapered downwardly, and having an outer conical surface; a spray mouth protruding down from a lower end of the alignment portion; and a flow channel formed through the spray nozzle head, the alignment portion and the spray mouth;
providing an air nozzle, wherein the air nozzle has:
   an air nozzle body having an alignment recess and a spray mouth recess; the alignment recess tapered from a top of the air nozzle body towards a bottom of the air nozzle body such that the alignment recess is formed as a conical space and an inner conical surface is defined around the alignment recess, wherein a taper angle of the outer conical surface of the alignment portion of the spray nozzle is equal to or greater than a taper angle of the inner conical surface of the air nozzle body of the air nozzle and a difference between the taper angle of the outer conical surface and the taper angle of the inner conical surface is less than or equal to 1 degree; and
   an air nozzle head disposed on the top of the air nozzle body; and
placing the spray nozzle into the air nozzle, wherein the alignment portion of the spray nozzle is disposed in the alignment recess of the air nozzle, the inner conical surface and the outer conical surface correspondingly abut on each other, the spray mouth of the spray nozzle is disposed in the spray mouth recess of the air nozzle, and the air nozzle head of the air nozzle is mounted around the spray nozzle head of the spray nozzle.

With the design as described above, the spray nozzle and the air nozzle can be connected with each other without threaded structure, such that gap and tolerance therebetween can be reduced. Moreover, between the spray nozzle and the air nozzle, with the outer conical surface of the of the alignment portion and the inner conical surface of the air nozzle body that match with each other, the spray nozzle is able to slide with respect to the air nozzle to a predetermined position automatically. Accordingly, concentricity between the spray nozzle and the air nozzle is high, such that gel can be sprayed evenly.

### BRIEF DESCRIPTION OF THE DRAWINGS

FIG. 1 is an operational exploded bottom perspective view of a spray nozzle assembly of a spray valve in accordance with the present invention;

FIG. 2 is an exploded top perspective view of the spray nozzle assembly in FIG. 1;

FIG. 3 is an operational cross-sectional side view of the spray nozzle assembly in FIG. 1;

FIG. 4 is another operational cross-sectional side view of the spray nozzle assembly in FIG. 1;

FIG. 5 is an exploded cross-sectional side view of a spray nozzle and an air nozzle of the spray nozzle assembly in FIG. 1;

FIG. 6 is a schematic flow chart of an alignment assembling method of the spray nozzle assembly in accordance with the present invention;

FIG. 7 is an operational cross-sectional side view of a spray nozzle assembly of a spray valve in accordance with the prior art; and

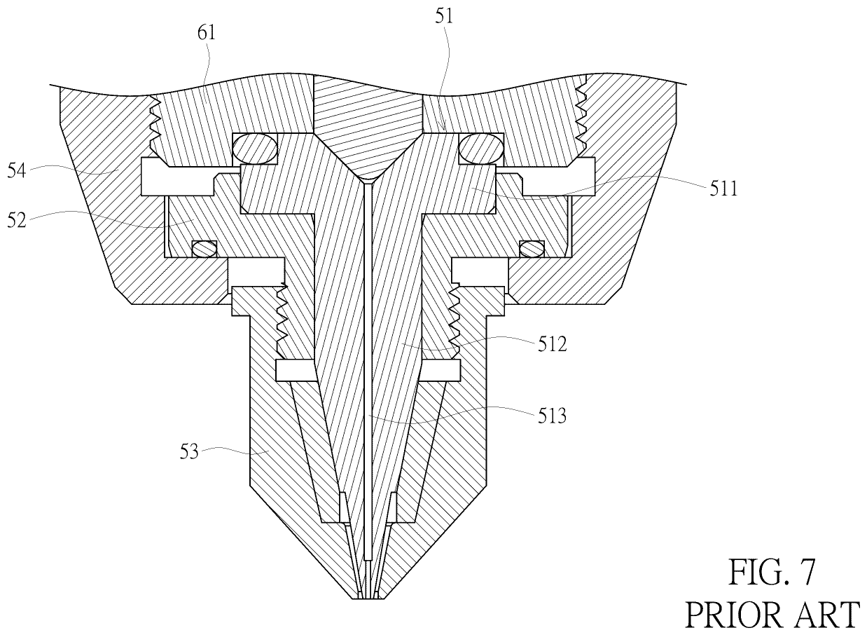

FIG. 8 is an operational schematic side view of the spray nozzle assembly in FIG. 7.

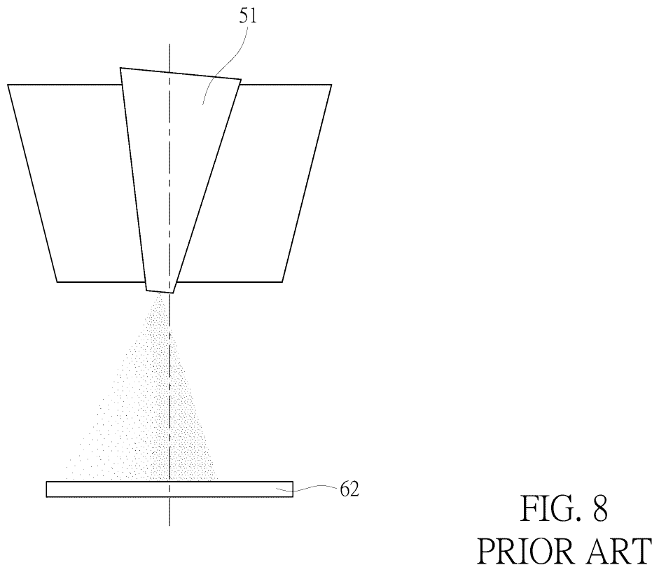

### DETAILED DESCRIPTION OF PREFERRED EMBODIMENTS

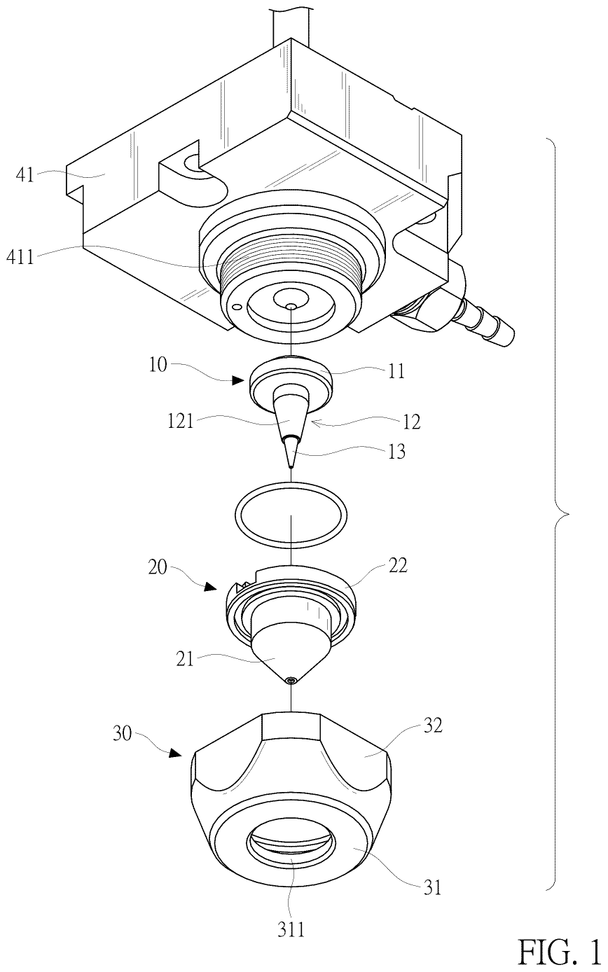

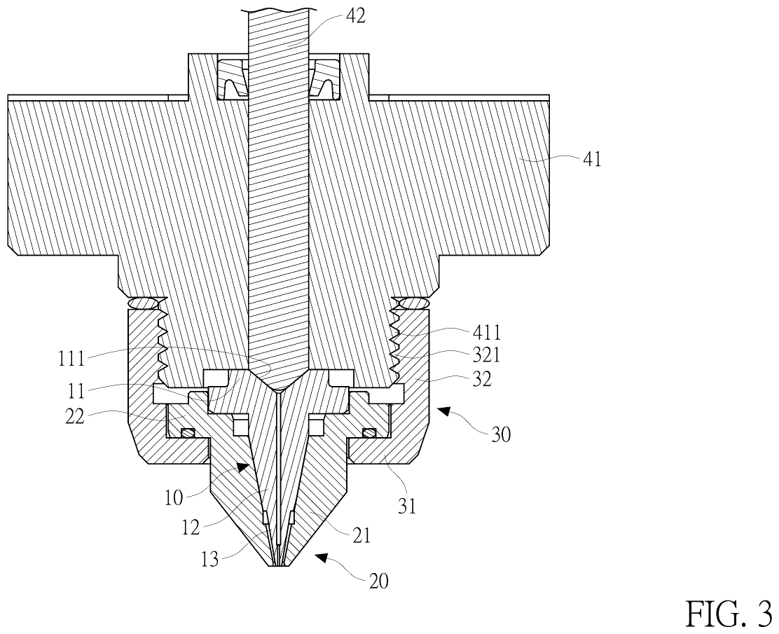

With reference to FIGS. 1 to 3, a spray nozzle assembly of a spray valve in accordance with the present invention is configured to be mounted on a bottom of a valve body 41 of the spray valve. A firing pin 42 is mounted in the valve body 41 and is linearly movable. The spray nozzle assembly corresponds in position to the firing pin 42 and comprises a spray nozzle 10, an air nozzle 20, and a mounting seat 30.

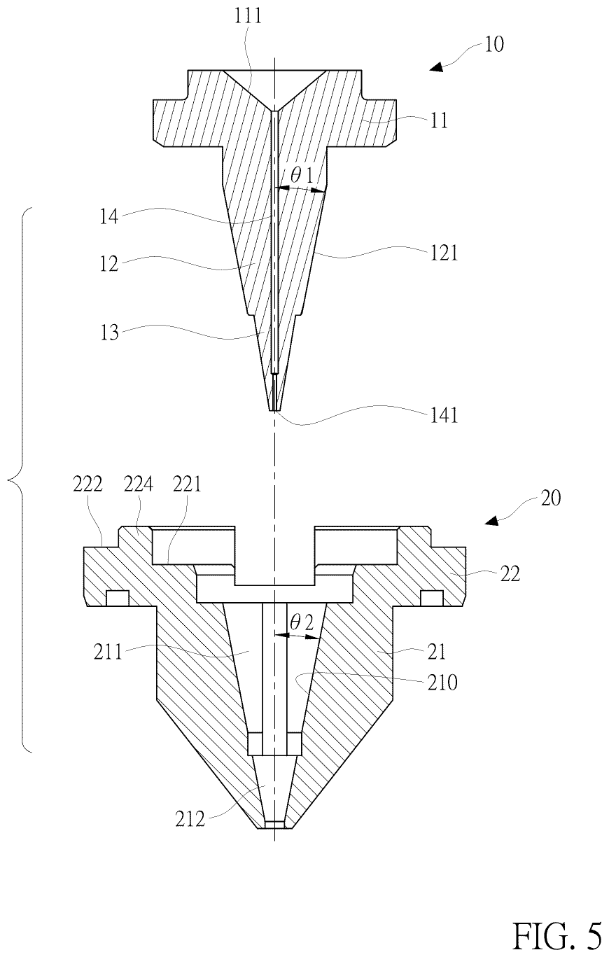

With further reference to FIG. 5, the spray nozzle 10 has a spray nozzle head 11, an alignment portion 12, a spray mouth 13, and a flow channel 14. The spray nozzle head 11 has an impacted recess 111. The impacted recess 111 is formed in a top surface of the spray nozzle head 11 and is tapered. The alignment portion 12 protrudes down from a bottom surface of the spray nozzle head 11, is tapered downwardly, and has an outer conical surface 121. The spray mouth 13 further protrudes down from a lower end of the alignment portion 12 and is also tapered downwardly. The flow channel 14 is formed through the spray nozzle head 11, the alignment portion 12 and the spray mouth 13, and extends between the impacted recess 111 of the spray nozzle head 11 and a bottom end of the spray mouth 13. The flow channel 14 forms an outlet 141 in the bottom end of the spray mouth 13.

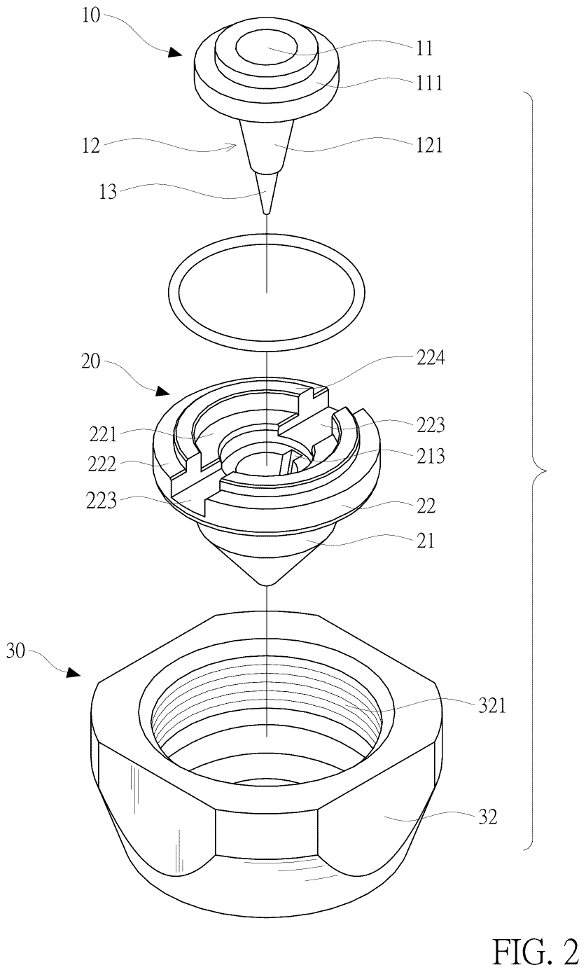

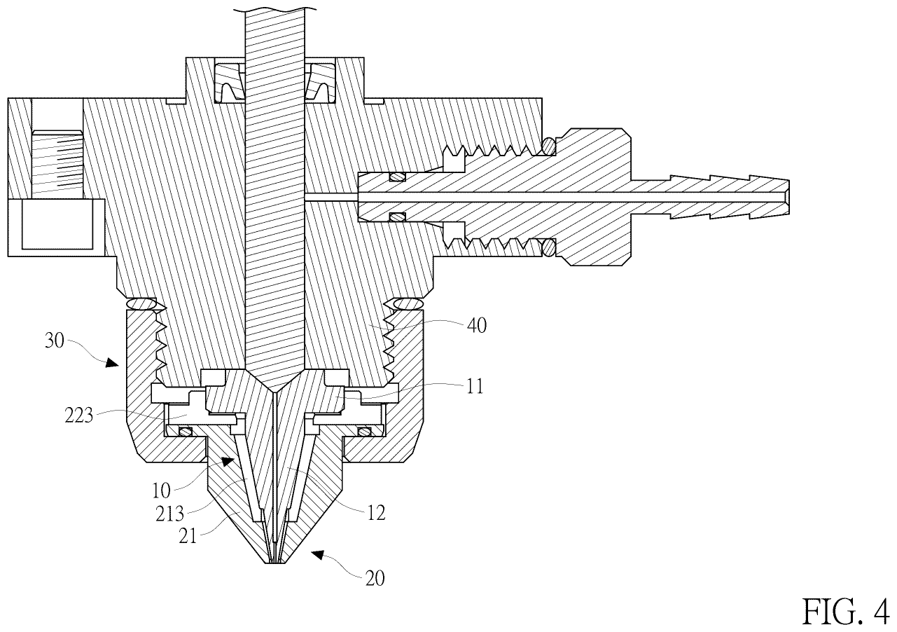

With further reference to FIGS. 2 to 5, the air nozzle 20 is mounted on the spray nozzle 10, such that the spray nozzle 10 is received in the air nozzle 20. The air nozzle 20 has an air nozzle body 21 and an air nozzle head 22.

The air nozzle body 21 has an alignment recess 211, a spray mouth recess 212 and at least one pair of longitudinal guiding grooves 213 formed within the air nozzle body 21. The alignment recess 211 is formed concavely in a top of the air nozzle body 21 and is tapered from the top of the air nozzle body 21 towards a bottom of the air nozzle body 21, such that the alignment recess 211 is formed as a conical space. An inner conical surface 210 is defined around the alignment recess 211 which is formed as said conical space. The alignment portion 12 of the spray nozzle 10 is correspondingly disposed in the alignment recess 211 of the air nozzle 20. A taper angle θ2 of the inner conical surface 210 matches with a taper angle θ1 of the outer conical surface 121 of the alignment portion 12 of the spray nozzle 10, such that the inner conical surface 210 correspondingly abuts on the outer conical surface 121.

Preferably, the taper angle θ1 of the outer conical surface 121 of the alignment portion 12 is equal to or slightly greater than the taper angle θ2 of the inner conical surface 210 of the air nozzle body 21 of the air nozzle 20. A difference between the taper angle θ1 of the outer conical surface 121 and the taper angle θ2 of the inner conical surface 210 is less than or equal to 1 degree. Specifically, in the preferred embodiment, the taper angle θ1 of the outer conical surface 121 of the alignment portion 12 is 14 degrees and the taper angle θ2 of the inner conical surface 210 of the air nozzle body 21 of the air nozzle 20 is 15 degrees.

The spray mouth recess 212 is formed within the air nozzle body 21, and is penetrated through and formed between the alignment recess 211 and the bottom of the air nozzle body 21. The spray mouth 13 of the spray nozzle 10 is correspondingly disposed in the spray mouth recess 212 of the air nozzle body 21 of the air nozzle 20, and a gap is formed between the spray mouth 13 and the air nozzle body 21.

The at least one pair of longitudinal guiding grooves 213 is formed concavely in the inner conical surface 210 of the air nozzle body 21. The guiding grooves 213 of each pair of the at least one pair of longitudinal guiding grooves 213 are oppositely disposed in the alignment recess 211 and are arranged along a radial direction of the alignment recess 211. An end of each of the guiding grooves 213 is formed through the top of the air nozzle body 21, and another end of each of the guiding grooves 213 communicates with the spray mouth recess 212.

As shown in FIGS. 2 to 5, the air nozzle head 22 is annular, is disposed on the top of the air nozzle body 21, and is disposed around the alignment recess 211. The air nozzle head 22 has an inner annular recess 221, an outer annular recess 222, an annular protrusion 224, and two side recesses 223. The inner annular recess 221 and the outer annular recess 222 are formed concavely in a top surface of the air nozzle head 22 and are arranged concentrically and separately. The annular protrusion 224 is formed between the inner annular recess 221 and the outer annular recess 222. In the preferred embodiment, the inner annular recess 221 is deeper than the outer annular recess 222. The spray nozzle head 11 of the spray nozzle 10 is correspondingly disposed in the inner annular recess 221 of the air nozzle head 22 of the air nozzle 20, and the air nozzle head 22 is disposed around the spray nozzle head 11. The side recesses 223 are radially formed through the air nozzle head 22 and are arranged oppositely in the air nozzle head 22 along a radial direction of the air nozzle head 22.

The mounting seat 30 is mounted on and supports the air nozzle 20, and has a bottom panel 31 and an annular sidewall 32. The bottom panel 31 is annular and has a through hole 311 formed through the bottom panel 31. The annular sidewall 32 is bent and extends up from an outer peripheral edge of the bottom panel 31 and has an inner thread 321. The inner thread 321 is formed on an inner side surface of the annular sidewall 32. The air nozzle head 22 of the air nozzle 20 is disposed on the bottom panel 31 of the mounting seat 30. The air nozzle body 21 of the air nozzle 20 is mounted through the through hole 311 of the bottom panel 31 and protrudes downward.

The inner thread 321 of the annular sidewall 32 of the mounting seat 30 is configured to be assembled with an outer thread 411 formed on an outer side surface of the valve body 41 of the spray valve, so as to assemble the spray nozzle assembly on the valve body 41. Thus, the inner annular recess 221, the outer annular recess 222, and the two side recesses 223 of the air nozzle head 22 of the air nozzle 20, the at least one pair of longitudinal guiding grooves 213 of the air nozzle body 21, and the gap between the spray mouth 13 and the air nozzle body 21 form an air channel, so as to provide air to the spray mouth 13 of the spray nozzle 10.

An impacting end of the firing pin 42 in the valve body 41 of the spray valve corresponds in position to the impacted recess 111 of the spray nozzle head 11 of the spray nozzle 10. The firing pin 42 is driven to linearly move away from or into the impacted recess 111 to push gel that is to be atomized into the flow channel 14. When the gel flows out from the outlet 141 of the flow channel 14, the gel is atomized by the air jetted from the air nozzle 20. Preferably, the outlet 141 of the flow channel 14 of the spray nozzle 10 is flush with the bottom of the air nozzle body 21.

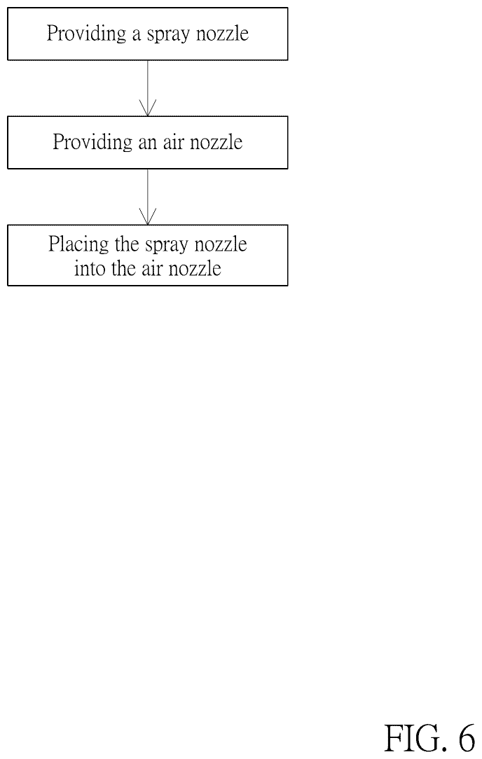

With further reference to FIG. 6, an alignment assembling method of the spray nozzle assembly is to assemble the spray nozzle 10 and the air nozzle 20. When the spray nozzle 10 is placed into the air nozzle 20, the alignment portion 12 of the spray nozzle 10 is disposed in the alignment recess 211 of the air nozzle 20, the inner conical surface 210 and the outer conical surface 121 correspondingly abut on each other, the spray mouth 13 of the spray nozzle 10 is disposed in the spray mouth recess 212 of the air nozzle 20, and the air nozzle head 22 of the air nozzle 20 is mounted around the spray nozzle head 11 of the spray nozzle 10.

The spray nozzle assembly of the spray valve as described has the following advantages. In the spray nozzle assembly, only the mounting seat 30 has the inner thread 321 for being connected to the valve body 41. The spray nozzle 10, the air nozzle 20 and the mounting seat 30 are able to be connected with each other without any threaded structure, so that gaps and tolerance formed due to the threaded structure can be effectively reduced. Moreover, with the taper angle θ1 of the outer conical surface 121 of the alignment portion 12 and the taper angle θ2 of the inner conical surface 210 of the air nozzle body 21, the spray nozzle 10 is able to slide with respect to the air nozzle 20 to a predetermined position automatically when being assembled to the air nozzle 20. Accordingly, concentricity between the spray nozzle 10 and the air nozzle 20 is high and the gel is able be sprayed on a component evenly.

What is claimed is:

1. A spray nozzle assembly of a spray valve, and the spray nozzle assembly comprising:
a spray nozzle having
a spray nozzle head;
an alignment portion protruding down from a bottom surface of the spray nozzle head, tapered downwardly, and having an outer conical surface;
a spray mouth protruding down from a lower end of the alignment portion; and
a flow channel formed through the spray nozzle head, the alignment portion and the spray mouth; and
an air nozzle mounted on the spray nozzle and having
an air nozzle body having
an alignment recess formed concavely in a top of the air nozzle body and tapered from the top of the air nozzle body towards a bottom of the air nozzle body such that the alignment recess is formed as a conical space and an inner conical surface is defined around the alignment recess, wherein the alignment portion of the spray nozzle is correspondingly disposed in the alignment recess of the air nozzle, and a taper angle of the inner conical surface matches with a taper angle of the outer conical surface of the alignment portion of the spray nozzle; and
a spray mouth recess formed within the air nozzle body, and penetrated through and formed between the alignment recess and the bottom of the air nozzle body, wherein the spray mouth of the spray nozzle is correspondingly disposed in the spray mouth recess; and
an air nozzle head disposed on the top of the air nozzle body and disposed around the spray nozzle head;
wherein the taper angle of the outer conical surface of the alignment portion of the spray nozzle is equal to or greater than the taper angle of the inner conical surface of the air nozzle body of the air nozzle; and
a difference between the taper angle of the outer conical surface and the taper angle of the inner conical surface is less than or equal to 1 degree.

2. The spray nozzle assembly of the spray valve as claimed in claim 1, wherein
the spray nozzle assembly further comprises a mounting seat having
a bottom panel having a through hole formed through the bottom panel; and
an annular sidewall bent and extending up from an outer peripheral edge of the bottom panel and having an inner thread formed on an inner side surface of the annular sidewall;
the air nozzle head of the air nozzle is disposed on the bottom panel of the mounting seat; and
the air nozzle body of the air nozzle is mounted through the through hole of the bottom panel and protruding downward.

3. The spray nozzle assembly of the spray valve as claimed in claim 1, wherein
the air nozzle body of the air nozzle has at least one pair of longitudinal guiding grooves formed concavely in the inner conical surface of the air nozzle body;
the guiding grooves of each pair of the at least one pair of longitudinal guiding grooves are oppositely disposed in the alignment recess and are arranged along a radial direction of the alignment recess; and
an end of each of the guiding grooves is formed through the top of the air nozzle body and another end of each of the guiding grooves communicates with the spray mouth recess.

4. The spray nozzle assembly of the spray valve as claimed in claim 2, wherein
the air nozzle body of the air nozzle has at least one pair of longitudinal guiding grooves concavely formed in the inner conical surface of the air nozzle body;
the guiding grooves of each pair of the at least one pair of longitudinal guiding grooves are oppositely disposed in the alignment recess and are arranged along a radial direction of the alignment recess; and
an end of each of the guiding grooves is formed through the top of the air nozzle body and another end of each of the guiding grooves communicates with the spray mouth recess.

5. The spray nozzle assembly of the spray valve as claimed in claim 1, wherein the air nozzle head of the air nozzle has two side recesses radially formed through the air nozzle head and arranged oppositely in the air nozzle head along a radial direction of the air nozzle head.

6. The spray nozzle assembly of the spray valve as claimed in claim 2, wherein the air nozzle head of the air nozzle has two side recesses radially formed through the air nozzle head and arranged oppositely in the air nozzle head along a radial direction of the air nozzle head.

7. The spray nozzle assembly of the spray valve as claimed in claim 3, wherein the air nozzle head of the air nozzle has two side recesses radially formed through the air nozzle head and arranged oppositely in the air nozzle head along a radial direction of the air nozzle head.

8. The spray nozzle assembly of the spray valve as claimed in claim 4, wherein the air nozzle head of the air nozzle has two side recesses radially formed through the air nozzle head and arranged oppositely in the air nozzle head along a radial direction of the air nozzle head.

9. The spray nozzle assembly of the spray valve as claimed in claim 5, wherein the air nozzle head of the air nozzle has
an inner annular recess;
an outer annular recess, and the inner annular recess and the outer annular recess formed concavely in a top surface of the air nozzle head and arranged concentrically and separately; and
an annular protrusion formed between the inner annular recess and the outer annular recess.

10. The spray nozzle assembly of the spray valve as claimed in claim 6, wherein the air nozzle head of the air nozzle has
an inner annular recess;
an outer annular recess, and the inner annular recess and the outer annular recess formed concavely in a top surface of the air nozzle head and arranged concentrically and separately; and
an annular protrusion formed between the inner annular recess and the outer annular recess.

11. The spray nozzle assembly of the spray valve as claimed in claim 7, wherein the air nozzle head of the air nozzle has
an inner annular recess;
an outer annular recess, and the inner annular recess and the outer annular recess formed concavely in a top surface of the air nozzle head and arranged concentrically and separately; and
an annular protrusion formed between the inner annular recess and the outer annular recess.

12. The spray nozzle assembly of the spray valve as claimed in claim 8, wherein the air nozzle head of the air nozzle has
an inner annular recess;
an outer annular recess, and the inner annular recess and the outer annular recess formed concavely in a top surface of the air nozzle head and arranged concentrically and separately; and
an annular protrusion formed between the inner annular recess and the outer annular recess.

13. The spray nozzle assembly of the spray valve as claimed in claim 9, wherein the inner annular recess is deeper than the outer annular recess.

14. The spray nozzle assembly of the spray valve as claimed in claim 10, wherein the inner annular recess is deeper than the outer annular recess.

15. The spray nozzle assembly of the spray valve as claimed in claim 11, wherein the inner annular recess is deeper than the outer annular recess.

16. The spray nozzle assembly of the spray valve as claimed in claim 12, wherein the inner annular recess is deeper than the outer annular recess.

17. The spray nozzle assembly of the spray valve as claimed in claim 1, wherein the taper angle of the outer conical surface of the alignment portion of the spray nozzle is 14 degrees and the taper angle of the inner conical surface of the air nozzle body of the air nozzle is 15 degrees.

18. The spray nozzle assembly of the spray valve as claimed in claim 17, wherein the flow channel forms an outlet in a bottom end of the spray mouth and the outlet of the flow channel of the spray nozzle is flush with the bottom of the air nozzle body.

19. The spray nozzle assembly of the spray valve as claimed in claim 1, wherein the flow channel forms an outlet in a bottom end of the spray mouth and the outlet of the flow channel of the spray nozzle is flush with the bottom of the air nozzle body.

20. An alignment assembling method of a spray nozzle assembly comprising steps of:
providing a spray nozzle, wherein the spray nozzle has
a spray nozzle head;
an alignment portion protruding down from a bottom surface of the spray nozzle head, tapered downwardly and having an outer conical surface;
a spray mouth protruding down from a lower end of the alignment portion; and
a flow channel formed through the spray nozzle head, the alignment portion and the spray mouth;
providing an air nozzle, wherein the air nozzle has
an air nozzle body having
an alignment recess tapered from a top of the air nozzle body towards a bottom of the air nozzle body such that the alignment recess is formed as a conical space and an inner conical surface is defined around the alignment recess, wherein a taper angle of the outer conical surface of the alignment portion of the spray nozzle is equal to or greater than a taper angle of the inner conical surface of the air nozzle body of the air nozzle and a difference between the taper angle of the outer conical surface and the taper angle of the inner conical surface is less than or equal to 1 degree; and
a spray mouth recess; and
an air nozzle head disposed on the top of the air nozzle body; and
placing the spray nozzle into the air nozzle, wherein the alignment portion of the spray nozzle is correspondingly disposed in the alignment recess of the air nozzle, the inner conical surface and the outer conical surface correspondingly abut on each other, the spray mouth of the spray nozzle is correspondingly disposed in the spray mouth recess of the air nozzle, and the air nozzle head of the air nozzle is mounted around the spray nozzle head of the spray nozzle.
